(19) United States
(12) Patent Application Publication
(10) Pub. No.: US 2025/0004277 A1
(43) Pub. Date: Jan. 2, 2025

(54) VIRTUAL IMAGE DISPLAY DEVICE AND OPTICAL UNIT

(71) Applicant: SEIKO EPSON CORPORATION, Tokyo (JP)

(72) Inventor: Takashi TAKEDA, Suwa-shi (JP)

(73) Assignee: SEIKO EPSON CORPORATION, Tokyo (JP)

(21) Appl. No.: 18/757,454

(22) Filed: Jun. 27, 2024

(30) Foreign Application Priority Data
Jun. 30, 2023 (JP) 2023-107969

(51) Int. Cl. G02B 27/01; G02B 3/12; G02B 6/34

(52) U.S. Cl. CPC G02B 27/0172; G02B 3/12; G02B 6/34; G02B 2027/0178

(57) ABSTRACT

A virtual image display device includes: a first lens that has a positive refractive power and on which video light is incident from the display element, a first prism on which the video light passed through the first lens is incident, a second prism that is bonded to the first prism and that forms a prism light-guiding member, a polarized light separation film that is provided at a bonding site of the first prism and the second prism, an angle selection film disposed on an outer surface in the prism light-guiding member, a second lens that is disposed in a facing manner to the angle selection film, a transmissive mirror that is disposed on a convex surface of the second lens, a quarter-wavelength plate disposed between the angle selection film and the second lens, and a compensation lens that is bonded to the convex surface.

The present application is based on, and claims priority from JP Application Serial Number 2023-107969, filed Jun. 30, 2023, the disclosure of which is hereby incorporated by reference herein in its entirety.

### BACKGROUND

### 1. Technical Field

The present disclosure relates to a virtual image display device and an optical unit that are a see-through type and that enable observation of a virtual image.

### 2. Related Art

A known head-mounted display includes a display device, a projection optical member, a prism member, and an optical condensing/reflecting surface, and image light from the projection optical member is incident into a first prism included in the prism member, totally reflected at an outer surface of the prism member, partially reflected at a semi-transmissive reflective surface formed at a boundary between the first prism and a second prism included in the prism member, then transmitted through the outer surface of the prism member, reflected at the condensing/reflecting surface, returned to the prism member, transmitted through the semi-transmissive reflective surface, and further passed through an inner surface facing a pupil (see JP 2020-08749 A).

In the head-mounted display described above, since an intermediate image is formed in the first prism, an optical path length becomes long, and an optical system becomes large as a whole. In addition, since the projection optical member is disposed in a direction inclined toward a face with respect to the above of the prism member, the projection optical member is disposed close to the face and interference is likely to occur, so that the projection optical member is limited in arrangement and size.

### SUMMARY

According to an aspect of the present disclosure, there is provided a virtual image display device being a direct virtual image type, the virtual image display device including a display element configured to emit video light, a first lens having a positive refractive power, the first lens on which the video light is incident from the display element, a first prism on which the video light passed through the first lens is incident, a second prism bonded to the first prism, the second prism forming a prism light-guiding member having a parallel flat plate shape, a polarized light separation film provided at a bonding site of the first prism and the second prism, the polarized light separation film having a flat surface shape, the polarized light separation film being configured to selectively reflect the video light guided in the first prism in accordance with a polarization direction, an angle selection film disposed on an outer surface in the prism light-guiding member, on which the video light guided in the first prism and then reflected at the polarized light separation film is incident, the angle selection film being configured to exhibit a different separation characteristic depending on an incident angle of the video light, a second lens including a flat surface provided facing the angle selection film, the second lens having a plano-convex shape, a transmissive mirror disposed on a convex surface of the second lens, the transmissive mirror being configured to partially reflect the video light reflected at the polarized light separation film toward the polarized light separation film, a quarter-wavelength plate disposed between the angle selection film and the flat surface of the second lens, and a compensation lens including a concave surface having a shape obtained by inverting the convex surface of the second lens, the concave surface being bonded to the convex surface through the transmissive mirror, and a flat surface parallel to an outer surface of the first prism.

According to an aspect of the present disclosure, there is provided an optical unit being a direct virtual image type, the optical unit including a first lens having a positive refractive power, on which video light is incident from a display element configured to emit the video light, a first prism on which the video light passed through the first lens is incident, a second prism bonded to the first prism, the second prism forming a prism light-guiding member having a parallel flat plate shape, a polarized light separation film provided at a bonding site of the first prism and the second prism, the polarized light separation film having a flat surface shape, the polarized light separation film being configured to selectively reflect the video light guided in the first prism in accordance with a polarization direction, an angle selection film disposed on an outer surface in the prism light-guiding member, on which the video light guided in the first prism and then reflected at the polarized light separation film is incident, the angle selection film being configured to exhibit a different separation characteristic depending on an incident angle of the video light, a second lens including a flat surface provided facing the angle selection film, the second lens having a plano-convex shape, a transmissive mirror disposed on a convex surface of the second lens, the transmissive mirror being configured to partially reflect the video light reflected at the polarized light separation film toward the polarized light separation film, a quarter-wavelength plate disposed between the angle selection film and the flat surface of the second lens, and a compensation lens including a concave surface having a shape obtained by inverting the convex surface of the second lens, the concave surface being bonded to the convex surface through the transmissive mirror, and a flat surface parallel to an outer surface of the first prism.

### BRIEF DESCRIPTION OF THE DRAWINGS

FIG. 1 is an external view for describing a used state of a virtual image display device according to a first embodiment.

FIG. 2 is a side cross-sectional view for describing an internal structure of a display device on one side.

FIG. 3 is a diagram illustrating reflection and transmission characteristics of an angle selection film.

FIG. 4 is a partially enlarged view for describing light beams transmitted through a first prism or reflected at the inside of the first prism.

FIG. 5 is a table showing examples of angles of view in an upward direction of a visual field angle.

FIG. 6 is a table showing examples of angles of view in a downward direction of the visual field angle.

FIG. 7 is a perspective view for describing an external structure of a first display unit.

FIG. 8 is a diagram for describing shapes and the like of a first image forming element and a first lens.

FIG. 9 is a perspective view for describing an example of a structure and assembly of the first display unit.

FIG. 10 is a cross-sectional view for describing an example of the assembly of the first display unit.

FIG. 11 is a cross-sectional view for describing an example of assembly of a first display unit of a virtual image display device according to a second embodiment.

FIG. 12 is a side cross-sectional view for describing a virtual image display device according to a third embodiment.

FIG. 13 is a conceptual diagram for describing an operation of the virtual image display device illustrated in FIG. 12.

FIG. 14 is a conceptual diagram for describing an operation of a modification of the virtual image display device illustrated in FIG. 12.

### DESCRIPTION OF EMBODIMENTS

### First Embodiment

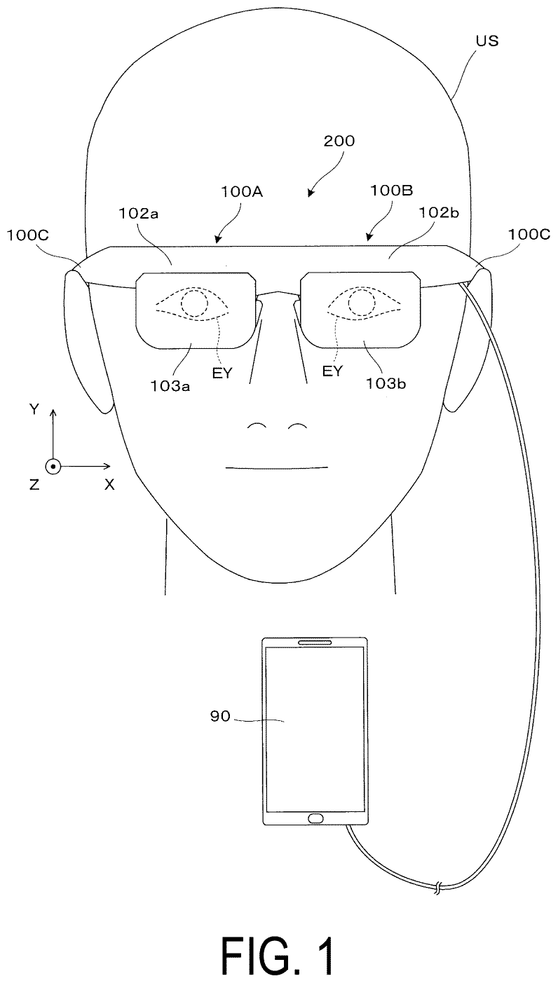

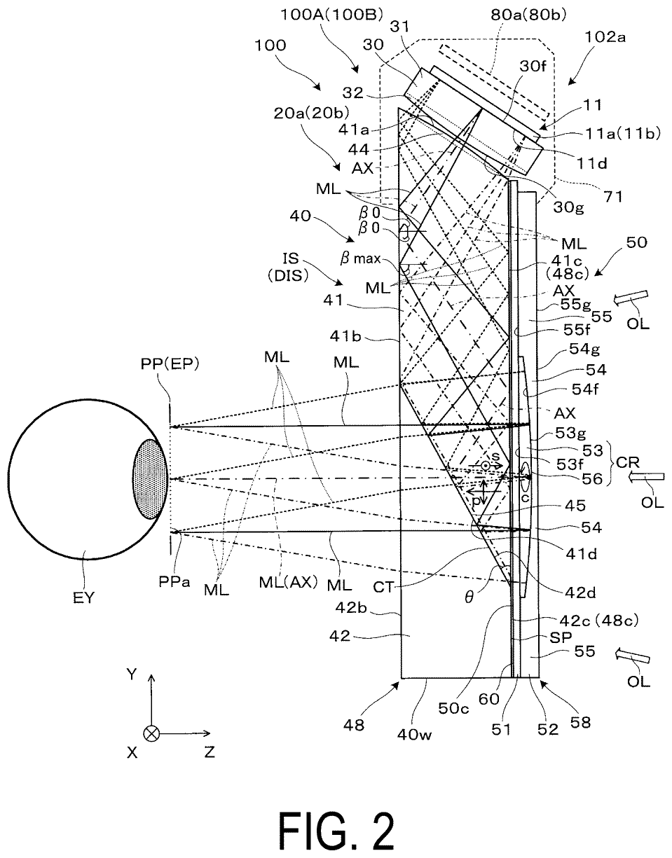

A first embodiment of a virtual image display device and the like according to the present disclosure will be described below with reference to FIGS. 1, 2 and the like.

FIG. 1 is a diagram for describing a mounted state of a head-mounted virtual image display device (hereinafter, also referred to as a head-mounted display or an “HMD”) 200, and the HMD 200 allows an observer or wearer US who is wearing the HMD 200 to recognize a video as a virtual image. In FIG. 1 and the like, X, Y, and Z indicate an orthogonal coordinate system, a +X direction corresponds to a lateral direction in which both eyes EY of the observer or wearer US wearing the HMD 200 are aligned, a +Y direction corresponds to an upward direction orthogonal to the lateral direction in which both the eyes EY are aligned for the wearer US, and a +Z direction corresponds to a forward or front direction for the wearer US. The ±Y directions are parallel to a vertical axis or a vertical direction.

The HMD 200 includes a first virtual image display device 100A that is for a right eye and of a direct virtual image type, a second virtual image display device 100B that is for a left eye and of a direct virtual image type, a pair of support devices 100C that have a temple shape and that support the virtual image display devices 100A and 100B, and a user terminal 90 as an information terminal. The first virtual image display device 100A alone functions as an HMD, and is constituted by a first display driving unit 102a disposed at an upper portion thereof, and a first combiner 103a that has a spectacle lens shape and that covers a front of the eye. Similarly, the second virtual image display device 100B alone functions as an HMD, and is constituted by a second display driving unit 102b disposed at an upper portion thereof, and a second combiner 103b that has a spectacle lens shape and that covers a front of the eye. The support devices 100C are mounting members to be mounted on the head of the wearer US, and support upper end sides of the pair of combiners 103a and 103b by using the display driving units 102a and 102b that are integrated in appearance. The first virtual image display device 100A and the second virtual image display device 100B are optically identical or inverted to each other in a left-right direction, and detailed description of the second virtual image display device 100B will be omitted.

FIG. 2 is a side cross-sectional view for describing an internal structure of the first virtual image display device 100A. The first virtual image display device 100A includes a first image forming element 11a, a first display unit 20a, and a first circuit member 80a. The first image forming element 11a is also referred to as a display element 11. The first display unit 20a is an imaging optical system IS that directly forms a virtual image without forming an intermediate image and is also referred to as a direct virtual image optical system DIS. The imaging optical system IS includes a first lens 30, a first flat plate member 40, and a second flat plate member 50. The first lens 30 functions as a protective glass that protects a display surface lid of the display element 11. The first flat plate member 40 guides the video light ML emitted from the display element 11 to a second lens 53 of the second flat plate member 50. The second flat plate member 50 reflects the video light ML toward a pupil position PP or an eye EY by partially returning the video light ML from the first flat plate member 40 to the first flat plate member 40, and causes an external light OL to be incident at the pupil position PP through the first flat plate member 40. Each of the first lens 30, the first flat plate member 40, and the second flat plate member 50 has a function as a lens having a positive refractive power.

Although detailed description will be omitted, the second virtual image display device 100B includes a second image forming element 11b, a second display unit 20b, and a second circuit member 80b. The second image forming element bib is similar to the first image forming element 11a, the second display unit 20b is similar to the first display unit 20a, and the second circuit member 80b is similar to the first circuit member 80a.

In the first virtual image display device 100A, the first image forming element 11a is an image light generating device of a self-luminous type. The first image forming element 11a emits the video light ML to the first flat plate member 40 through the first lens 30. The first image forming element 11a is housed in and supported by a case 71. The first image forming element 11a is, for example, an organic electro-luminescence (EL) display, and forms a color still image or moving image on the display surface lid that is two-dimensional. The first image forming element 11a is driven by the first circuit member 80a to perform a display operation. The first image forming element 11a is not limited to the organic EL display, and may be replaced with a display device using inorganic EL, an organic LED, an LED array, a laser array, a quantum dot light-emitting element, or the like. The first image forming element 11a is not limited to the image light generating device of the self-luminous type, and it may be possible to employ a device including an LCD or other optical modulation elements and illuminating the optical modulation elements using a light source such as backlight to form an image. As for the first image forming element 11a, it may be possible to use liquid crystal on silicon (LCOS, LCoS is a registered trademark), a digital micro-mirror device, or the like, instead of the LCD. Note that an optical device obtained by excluding the first circuit member 80a from the first virtual image display device 100A is referred to as an optical unit 100. It can also be said that the optical unit 100 includes an optical system of a direct virtual image type and is a portion corresponding to the direct virtual image optical system DIS constituting the first virtual image display device 100A.

The first display unit 20a includes the first lens 30, the first flat plate member 40, a polarized light separation film 45, and the second flat plate member 50. In the first display unit 20a, the first lens 30 has a positive refractive power, and is incident thereon with the video light ML from the first image forming element 11a. The first lens 30 includes a light incident surface 30f being a flat surface and bonded to the first image forming element 11a and a light emission surface 30g being a convex surface. The light emission surface 30g is, for example, a spherical surface, but may be an aspherical surface having an axially symmetric shape. The first lens 30 can be considered to be divided into a parallel flat plate 31 and a lens portion 32. Ensuring that a thickness of the parallel flat plate 31 is equal to or larger than a predetermined value causes a foreign matter adhering to a surface of the first lens 30 to become less noticeable. The lens portion 32 is a plano-convex lens having a positive refractive power. In the plano-convex lens, one surface has a flat surface shape and the other surface has a convex surface shape. The first lens 30 is made of fused quartz, for example, and has a relatively low refractive index.

The first flat plate member 40 includes a first prism 41 having a parallel flat plate shape and a second prism 42 having a parallel flat plate shape. The first prism 41 and the second prism 42 are bonded at inclined surfaces 41d and 42d. The first prism 41 and the second prism 42 bonded to each other is referred to as a prism light-guiding member 48. The prism light-guiding member 48 has an appearance of a parallel flat plate. The polarized light separation film 45 having a flat surface shape is formed on the inclined surface 41d formed at the lower side of the first prism 41. A combination of the prism light-guiding member 48 and the second flat plate member 50, which will be described later, corresponds to the first combiner 103a in FIG. 1.

The first prism 41 has an outer shape of a quadratic prism shape and includes a trapezoidal vertical cross section. The first prism 41 guides the video light ML, and includes an incident optical surface 41a, an inner surface 41b, an outer surface 41c, and the inclined surface 41d. Here, the incident optical surface 41a is inclined downward and forward as a whole, and an optical axis passing through the incident optical surface 41a extends in a direction between the +Z direction that is forward and the +Y direction that is upward. Accordingly, the first image forming element 11a that is the display element 11 can be easily disposed at the further external environment side than the inner surface 41b, and an angle at which the video light ML propagates in the first prism 41 (in the first prism 41 or inside the first prism 41) can be adjusted. The incident optical surface 41a is a convex surface, for example a spherical surface, but may also be an aspherical surface having an axially symmetric shape. The first prism 41 can be considered to include a lens portion 44 including the incident optical surface 41a. The lens portion 44 is a plano-convex lens having a positive refractive power. The inner surface 41b and the outer surface 41c are parallel to each other, and extend perpendicularly to an optical axis AX between the pupil position PP, and the inner surface 41b and the outer surface 41c. The inner surface 41b and the outer surface 41c internally reflect the video light ML (that is, reflect the video light ML at an inner side of an object surface), and in particular, it is desirable that the inner surface 41b and the outer surface 41c totally reflect the video light ML. Applying hard coating to the inner surface 41b can enhance scratch resistance or abrasion resistance. The inclined surface 41d is a flat surface. The inclined surface 41d forms an acute angle with respect to the outer surface 41c. Although details will be described later, the inclined surface 41d forms, specifically, an angle of 25° to 32°. Note that an interval between the optical axis AX passing through the pupil position PP and the first lens 30 is about 20 mm. The first prism 41 is formed of a resin material and has a refractive index higher than a refractive index of the first lens 30.

The number of reflections of the video light ML in the first prism 41 is one at the inner surface 41b, one at the outer surface 41c, and one at the polarized light separation film 45, which will be described later. Setting the number of reflections of the video light ML in the first prism 41 to two makes it possible to avoid mixing of light having the different number of reflections in the first prism 41 while increasing the angle of view of the video light ML, and the pupil position PP or an aperture PPa thereof. Since an intermediate image is not formed in the first display unit 20a or the imaging optical system IS, the video light ML reflected by the inner surface 41b and the outer surface 41c is less diverged than the video light ML initially emitted from the first image forming element 11a. However, the video light ML is incident on the inner surface 41b and the outer surface 41c in the diverged state, and the diverged state is maintained.

Similarly to the first prism 41, the second prism 42 has an outer shape of a quadratic prism and a trapezoidal vertical cross section. The second prism 42 transmits the video light ML, and includes an inner surface 42b, an outer surface 42c, and an inclined surface 42d. Here, the inner surface 42b and the outer surface 42c are parallel to each other and extend perpendicularly to the optical axis AX between the pupil position PP, and the inner surface 42b and the outer surface 42c. Applying hard coating to the inner surface 42b can enhance scratch resistance or abrasion resistance of the inner surface 42b. The second prism 42 is formed of a resin material and has a refractive index equal to a refractive index of the first prism 41.

The polarized light separation film 45 is integrally formed on the inclined surface 41d of the first prism 41, and is interposed between the inclined surface 41d of the first prism 41 and the inclined surface 42d of the second prism 42. A space between the polarized light separation film 45 and the inclined surface 42d is filled with an adhesive CT for bonding. The polarized light separation film 45 is formed of a dielectric multilayer film, efficiently reflects the video light ML of s-polarized light s when the video light ML includes the s-polarized light s, and efficiently transmits the video light ML of p-polarized light p when the video light ML includes the p-polarized light p. The polarized light separation film 45 may be any film that selectively reflects the video light ML according to a polarization direction, and may be, for example, a wire grid. The polarized light separation film 45 may be a flat surface to such an extent that the polarized light separation film 45 does not affect imaging. In addition, the polarized light separation film 45 may include a slightly curved surface that is convex or concave to such an extent that the polarized light separation film 45 does not affect imaging. Applying hard coating on the surface of the polarized light separation film 45 can enhance scratch resistance or abrasion resistance thereof. Note that a space between the polarized light separation film 45 and the inclined surface 41d may be filled with a transmissive filler instead of the adhesive CT. In this case, the first prism 41 and the second prism 42 may be supported by a support member or the like from the outside to maintain a joined state. Further, the polarized light separation film 45 may be integrally formed on the inclined surface 42d of the second prism 42 instead of the inclined surface 41d of the first prism 41.

When a reflection angle of the video light ML on the optical axis AX in the first prism 41 is β0, an inclination angle θ of the polarized light separation film 45 is equal to or more than 90°-β0. On the assumption that the polarized light separation film 45 does not obstruct a path of the video light ML, when a maximum reflection angle of the video light ML is βmax, the inclination angle θ of the polarized light separation film 45 is desirably smaller than βmax. The reflection angle β0 of the video light ML corresponds to an angle formed by a normal line of the inner surface 41b and the optical axis AX passing through the incident optical surface 41a, and is an acute angle. That is, the optical axis AX of the incident optical surface 41a extends in a direction forming an angle less than 90° with respect to the normal line of the inner surface 41b. Note that although details will be described later, the inclination angle θ of the polarized light separation film 45 corresponds to a PBS angle θ, which will be described later, and a range of the PBS angle θ is limited so that reflected light incident on an angle selection film 60, which will be described later, is reflected at the angle selection film 60. In addition, the reflection angle β0 corresponds to a case where a reflection incident angle γ, which will be described later, is related to the video light ML on the optical axis AX.

The second flat plate member 50 includes a quarter-wavelength plate 51 having a thin plate shape and a cover member 52. The quarter-wavelength plate 51 is a crystal or the like having an optical axis between the X direction and the Y direction, converts the video light ML of the s-polarized light s reflected by the polarized light separation film 45 into circularly polarized light c, and converts the video light ML of the circularly polarized light c reflected by the cover member 52 into p-polarized light p. The cover member 52 includes the second lens 53 having a plano-convex shape, a compensation lens 54 having a plano-concave shape, a compensation flat plate 55 provided around the compensation lens 54, and a transmissive mirror 56.

An angle selection film 60 is provided between the prism light-guiding member 48 and the second flat plate member 50. That is, the angle selection film 60 is provided between an outer surface 48c of the prism light-guiding member 48 or the outer surfaces 41c and 42c of the first flat plate member 40 and the inner surface 50c of the second flat plate member 50. By providing the angle selection film 60 on the outer surface 48c of the prism light-guiding member 48, there is no need to provide a clearance between the outer surfaces 41c and 42c of the first flat plate member 40 and the inner surface 50c of the second flat plate member 50. Thus, the second flat plate member 50 can be directly bonded onto the angle selection film 60. Specifically, the angle selection film 60 and the quarter-wavelength plate 51 of the second flat plate member 50 are bonded to each other with an adhesive. Note that it is preferable that the angle selection film 60 be provided, in particular, on the outer surface 41c of the first prism 41 of the first flat plate member 40.

The angle selection film 60 is an angle-dependent separation film that exhibits different separation characteristics depending on incident angles of light. The angle selection film 60 functions as a planar transmissive/reflective surface that transmits the video light ML reflected at the polarized light separation film 45 while reflecting the video light ML reflected at the inner surface 41b of the first prism 41.

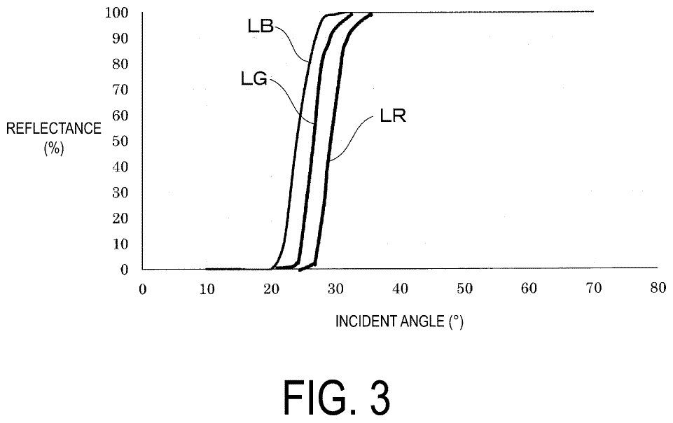

FIG. 3 is a diagram illustrating reflection and transmission characteristics of the angle selection film 60. In FIG. 3, the horizontal axis represents an incident angle (unit: °) of light incident on the outer surface 41c of the first prism 41, and the vertical axis represents a reflectance (unit: %) with respect to the incident angle. A reference sign LR denotes a red light beam, a reference sign LG denotes a green light beam, and a reference sign LB denotes a blue light beam. The angle selection film 60 is a film that transmits the video light ML when the incident angle is equal to or less than 20° and that reflects the video light ML when the incident angle is equal to or more than 40°.

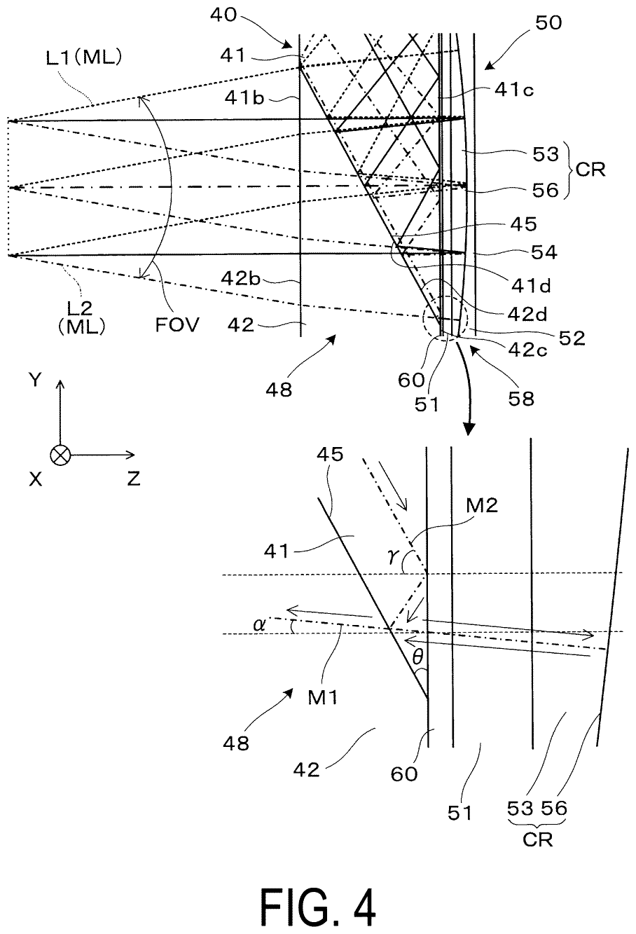

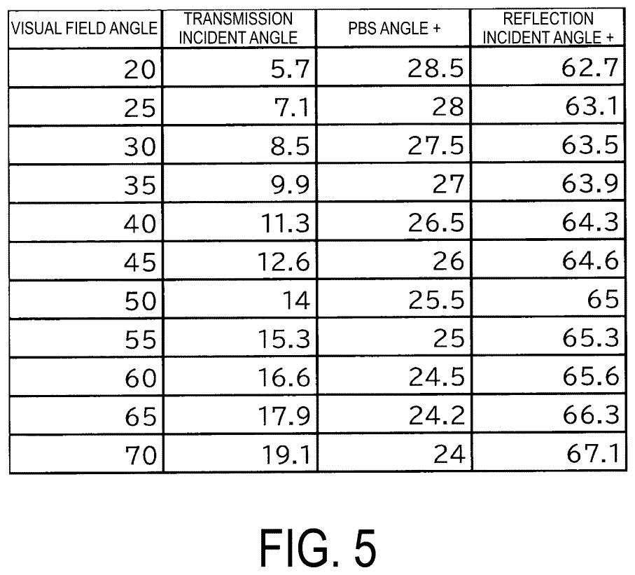

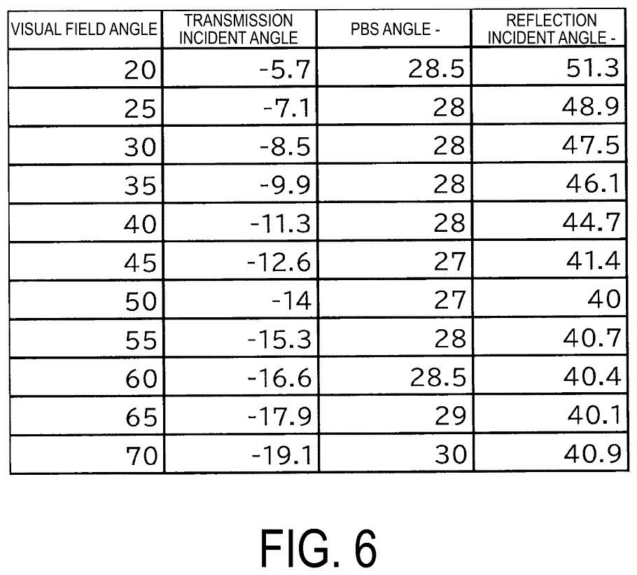

FIG. 4 is a partially enlarged view illustrating light beams transmitted through the first prism 41 of the prism light-guiding member 48 or reflected at the inside of the first prism 41. As indicated by a dotted line L1 in FIG. 4, an angle of view in the upward direction of the visual field angle is defined as +, and as indicated by a dashed-dotted line L2 in FIG. 4, an angle of view in the downward direction of the visual field angle FOV is defined as −. In the first prism 41 of the prism light-guiding member 48, an incident angle (transmission incident angle) of a transmission light beam M1 incident on the angle selection film 60 is denoted as a, and an incident angle (reflection incident angle) of a reflection light beam M2 incident on the angle selection film 60 is denoted as y. Additionally, an angle (PBS angle) formed by a surface of the polarized light separation film 45 and a surface of the angle selection film 60 is denoted as θ. Here, each of the angles α, γ, and θ is set on the assumption that a light beam travels from the pupil position PP. The refractive index of the first prism 41 is 1.75. FIG. 5 is a table showing an example of each angle for the angles of view in the upward direction of the visual field angle FOV. FIG. 6 is a table showing an example of each angle for the angles of view in the downward direction of the visual field angle FOV.

Hereinafter, a relationship between the visual field angle FOV and the polarized light separation film 45 will be described. The angle (PBS angle θ) of the inclined surface 41d of the first prism 41 on which the polarized light separation film 45 is formed needs to be reduced as the visual field angle FOV increases so that the reflection light beam M2 of the angle selection film 60 does not intersect with the surface of the polarized light separation film 45. Further, as shown in FIG. 6, the reflection incident angle γ is limited to a range in which the reflection light beam M2 incident on the angle selection film 60 is reflected at the angle selection film 60, to be more specific, to an angle range equal to or more than 40°.

The transmission incident angle α and the reflection incident angle γ shown in FIG. 5 and FIG. 6 can be expressed by the following Equations (1) and (2). The PBS angle θ is adjusted so as to satisfy the following Expressions (3) and (4).

$$α = {sin}^{- 1} ( \frac{sin ( \frac{FOV}{2} )}{2} ) \qquad ( 1 )$$

$$γ = 2 * θ + α \qquad ( 2 )$$

Here, a lower limit value of the PBS angle θ is expressed by the following expression.

$$θ > ( 90 - α ) / 3 \qquad ( 3 )$$

On the other hand, there is a condition for reflecting the reflection light beam M2 incident on the angle selection film 60. In the case of the present embodiment, since the light is reflected when the reflection incident angle γ is equal to or more than 40°, when 40 is substituted for the value y included in the above Equation (1), the following condition is obtained.

$$θ > ( 40 - α ) / 2 \qquad ( 4 )$$

The angle selection film 60 is a dielectric multilayer film in which a plurality of layers of dielectrics having different refractive indices are laminated. The angle selection film 60 has a film configuration with substantially no absorption and no polarization dependence. Specifically, the angle selection film 60 is constituted by, for example, a dielectric multilayer film in which a transparent film having a high refractive index (for example, TiO₂ or HfO₂) and a transparent film having a low refractive index (for example, SiO₂ or MgF₂) are alternately laminated.

In the cover member 52, the second lens 53 has a thin but positive refractive power, and includes a flat surface 53f bonded to the quarter-wavelength plate 51 and a convex surface 53g facing the compensation lens 54. The convex surface 53g is, for example, a spherical surface, but may also be an aspherical surface having an axially symmetric shape. The compensation lens 54 has a thin but positive refractive power and includes a concave surface 54f facing the second lens 53 and a flat surface 54g. The compensation flat plate 55 is a parallel flat plate, and includes a pair of flat surfaces 55f and 55g. Here, the concave surface 54f of the compensation flat plate 55 has the same shape as that of the convex surface 53g of the second lens 53. The flat surface 54g of the compensation lens 54 and the flat surface 55g of the compensation flat plate 55 are continuous on the same plane. The transmissive mirror 56 is a thin film formed on the convex surface 53g of the second lens 53, and has the same shape as that of the convex surface 53g. A combination of the second lens 53 and the transmissive mirror 56 is referred to as an optical condensing/reflecting portion CR.

The second lens 53 is formed by filling a filling space formed between a region of the cover member 52 corresponding to the compensation lens 54 and the quarter-wavelength plate 51 with an adhesive such as a photosetting resin. The photosetting resin is photo-cured after the filling. Examples of the photosetting resin include acrylic resin-based adhesives that are cured by ultraviolet rays or visible light, specifically, such as LOCTITE (registered trademark) AA3301 (manufactured by Henkel Corporation). Note that as the adhesive, a thermosetting resin can also be used.

Regarding the dimensions of the second lens 53, a diameter is from 20 mm to 25 mm, to be specific, about 22 mm. A central thickness of the second lens 53 is equal to or less than 3 mm, and is preferably from 1 mm to 1.7 mm. A thickness of an edge or outer periphery of the second lens 53 is from 0.2 mm to 0.5 mm.

When the second lens 53 is about 1 mm in thickness, the second lens 53 is difficult to be produced by polishing or injection molding. Thus, in the present embodiment, a concave curved surface corresponding to the compensation lens 54 facing the second lens 53 is used as a molding die in the cover member 52, and the second lens 53 is molded in assembling the first display unit 20a. Specifically, the second lens 53 is formed by bringing the cover member 52 excluding the second lens 53, that is, the compensation lens 54, and the quarter-wavelength plate 51 into contact with each other and filling the filling space with an adhesive through a flow path (not illustrated). By curing the adhesive, the second lens 53 is molded and the quarter-wavelength plate 51 and the cover member 52 are bonded to each other. Thus, even when the second lens 53 is thin, the second lens 53 can be easily formed. The adhesive has a refractive index equivalent to that of the compensation lens 54.

The compensation lens 54 and the compensation flat plate 55 are made of a resin material. The second lens 53, the compensation lens 54, and the compensation flat plate 55 have the same refractive index. The refractive index of the second lens 53 and the like is lower than the refractive index of the first prism 41. The compensation lens 54 and the compensation flat plate 55 are an optical element 58 integrally made of the same resin material.

A combination of the second lens 53, the compensation lens 54 and the compensation flat plate 55 functions as a parallel flat plate as a whole. That is, the external light OL incident at a position of the compensation lens 54 or the compensation flat plate 55 passes through the compensation lens 54 or the compensation flat plate 55 without being affected by a lens effect by the compensation lens 54 or the like or a step present at an outer edge of the compensation lens 54. The flat surfaces 54g and 55g of the compensation lens 54 and the compensation flat plate 55 may be provided with an antireflective film or be subjected to hard coating. The external light OL passed through the compensation flat plate 55 passes through the upper, lower, left, and right sides of the compensation lens 54, and is incident from a peripheral region outside the incident region of the video light ML corresponding to the compensation lens 54, that is, from the compensation flat plate 55. This makes it possible to ensure a wide see-through visual field for an external environment. A visual field range of the external light OL is set to, for example, about 400 in the upward direction and about 40° in the downward direction.

As described above, the diameter of the second lens 53 is set to 20 mm to 25 mm from the viewpoint of securing the angles of view. Note that since thicknesses of the first flat plate member 40 or the prism light-guiding member 48 in the Z direction are from 6 mm to 8 mm and distances from the inner surfaces 41b and 42b of the first flat plate member 40 to the pupil position PP are about from 12 mm to 13 mm, the angle of view (diagonal angle of view) that is an angle range in which the video light ML is incident at the pupil position PP can be set to about 40°.

The transmissive mirror 56 is a half mirror, and partially reflects the video light ML passed through the second lens 53 and partially transmits the external light OL. The transmissive mirror 56 reflects the video light ML that has been reflected at the polarized light separation film 45 of the first flat plate member 40 and then has passed through the angle selection film 60, the quarter-wavelength plate 51, and the second lens 53, toward the pupil position PP. The transmissive mirror 56 is a concave mirror that covers the pupil position PP at which the eye EY or the pupil is disposed, that has a concave shape toward the pupil position PP, and that has a convex shape toward the external environment. The pupil position PP or the aperture PPa thereof is referred to as an eye point or an eye box, and corresponds to an emission pupil EP of the first display unit 20a.

The transmissive mirror 56 transmits a part of the external light OL therethrough, which enables see-through view of the external environment, and thus enables a virtual image to be superimposed on an external image. At this time, the external light OL passes through the first flat plate member 40 and the second flat plate member 50, but the flat plate members 40 and 50 do not cause a lens effect on the external light OL. A reflectance of the transmissive mirror 56 for each of the video light ML and the external light OL is set to a value equal to or more than 10% and equal to or less than 50% in an incident angle range of the assumed video light ML from the viewpoint of ensuring a brightness of the video light ML and facilitating see-through observation of the external image. The transmissive mirror 56 is formed of, for example, a dielectric multilayer film constituted by a plurality of dielectric layers each of which has an adjusted film thickness. The transmissive mirror 56 may be a single layer film or a multilayer film of a metal such as Al or Ag. In this case, a film thickness thereof has been adjusted. The transmissive mirror 56 is formed by, for example, lamination using vapor deposition.

In the first virtual image display device 100A, each of the first lens 30, the lens portion 44, the second lens 53, and the transmissive mirror 56 has a positive refractive power and causes divergent light to have a converging tendency. The first lens 30, the lens portion 44, the second lens 53, and the transmissive mirror 56, including a main body of the first prism 41, the second prism 42, and the like, function as an imaging optical system IS or a direct virtual image optical system DIS such as a simple microscope type of microscope that forms an erect image. Thus, a real image formed on the display surface lid of the first image forming element 11a can be formed as a virtual image projected to the infinity, for example, or a real image formed on the display surface lid can be formed as a virtual image projected several meters ahead. At this time, adjusting refractive powers of the first lens 30, the lens portion 44, the second lens 53, and the transmissive mirror 56 causes a focal length of the imaging optical system IS to be shortened to achieve a desired magnification rate.

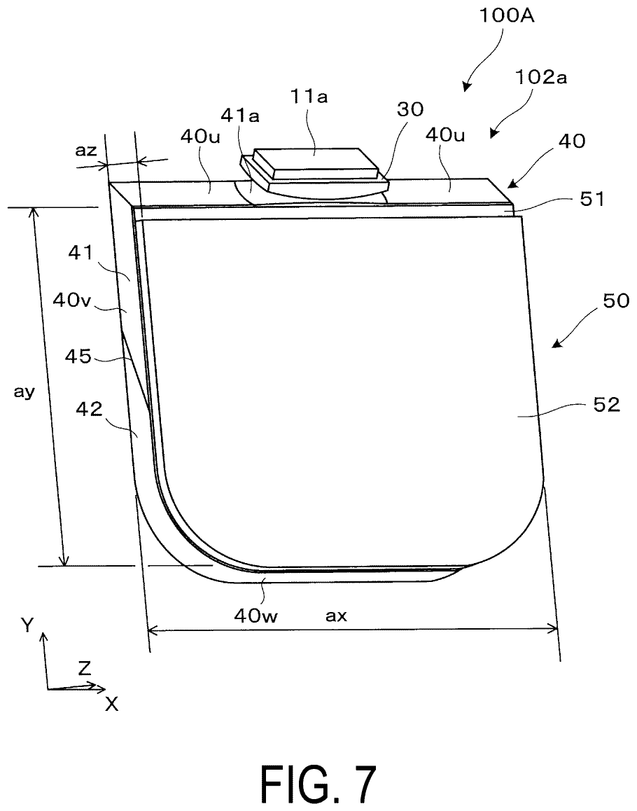

Referring to FIG. 7, a size ay in the vertical direction of the first flat plate member 40 or the second flat plate member 50 is, for example, 34 mm, and a size ax in the horizontal direction thereof is, for example, 40 mm. A thickness az of the first flat plate member 40 in a front-rear direction is, for example, about 7 mm, and a total thickness of the first flat plate member 40 and the second flat plate member 50 is suppressed to about 7.5 mm. In the first flat plate member 40, upper flat surfaces 40u are provided on the left and right sides of the incident optical surface 41a. Light is not incident on the upper flat surfaces 40u. From the viewpoint of preventing stray light, a light-shielding body (not illustrated) may be disposed on the upper flat surface 40u so as to face the upper flat surface 40u and to cover the upper flat surface 40u, or the light-shielding body may be coated on the upper flat surface. Side flat surfaces 40v and a lower flat surface 40w may also be provided with a light-shielding body or the like for covering these surfaces. A light-shielding body or the like covering the periphery of the second flat plate member 50 can also be provided.

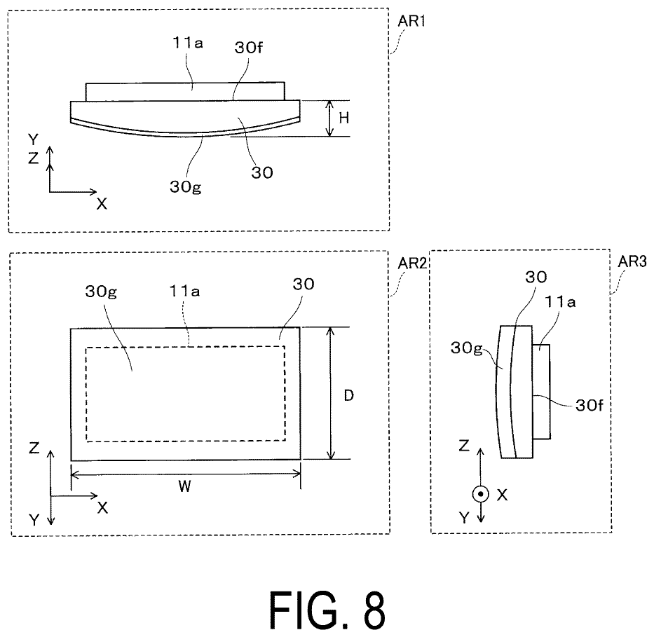

With reference to FIG. 8, shapes and the like of the first image forming element 11a and the first lens 30 will be described. In FIG. 8, a region AR1 indicates a state in which the first lens 30 and the like are viewed obliquely upward from the +Z side set as the front side, a region AR2 indicates a state in which the first lens 30 and the like are viewed obliquely forward from the −Y side set as the lower side, and a region AR3 indicates a state in which the first lens 30 and the like are viewed from the +X side set as the lateral side. A thickness or height H of the first lens 30 is, for example, approximately 2 mm, a width W of the first lens 30 is, for example, approximately 14 mm, and a depth D of the first lens 30 is, for example, approximately 7 mm.

A curvature radius of the light emission surface 30g with a convex shape of the first lens 30 is, for example, 20 mm. In addition, a curvature radius of the incident optical surface 41a of the first prism 41 illustrated in FIG. 2 is, for example, 14 mm, and a curvature radius of the transmissive mirror 56 is, for example, 47 mm.

Referring back to FIG. 2, an optical path will be described. The video light ML from the first image forming element 11a is incident on the first prism 41 through the first lens 30. At this time, the degree of divergence of the video light ML is suppressed by the positive refractive powers of the first lens 30 and the lens portion 44. In the optical path passing through the first prism 41, the video light ML is sequentially reflected by the inner surface 41b of the first prism 41 and the outer surface 41c of the first prism 41 without forming an intermediate image, and an s-component of the video light ML is reflected at the polarized light separation film 45. The video light ML of the s-polarized light s reflected by the polarized light separation film 45 is transmitted through the outer surface 41c of the first prism 41 and the angle selection film 60, is transmitted through the quarter-wavelength plate 51 of the second flat plate member 50 to become the circularly polarized light c, and then is incident on the transmissive mirror 56. The video light ML of the circularly polarized light c incident on the transmissive mirror 56 passes through the second lens 53, is partially reflected at the transmissive mirror 56, passes through the second lens 53, and passes through the quarter-wavelength plate 51 again in a collimated state. Accordingly, the video light ML that has passed through the quarter-wavelength plate 51 becomes p-polarized light p, passes through the angle selection film 60, is incident on the first prism 41 from the outer surface 41c, is transmitted through the polarized light separation film 45, and is emitted outside the second prism 42 through the inner surface 42b. The video light ML emitted outside the second prism 42 is incident at the pupil position PP at which the eye EY or pupil of the wearer US is placed. Not only the video light ML reflected at the transmissive mirror 56 but also the external light OL transmitted through the transmissive mirror 56 and the external light OL passed through the compensation flat plate 55 are incident at the pupil position PP. In other words, the wearer US wearing the first virtual image display device 100A can observe a virtual image of the video light ML superimposed on an external image.

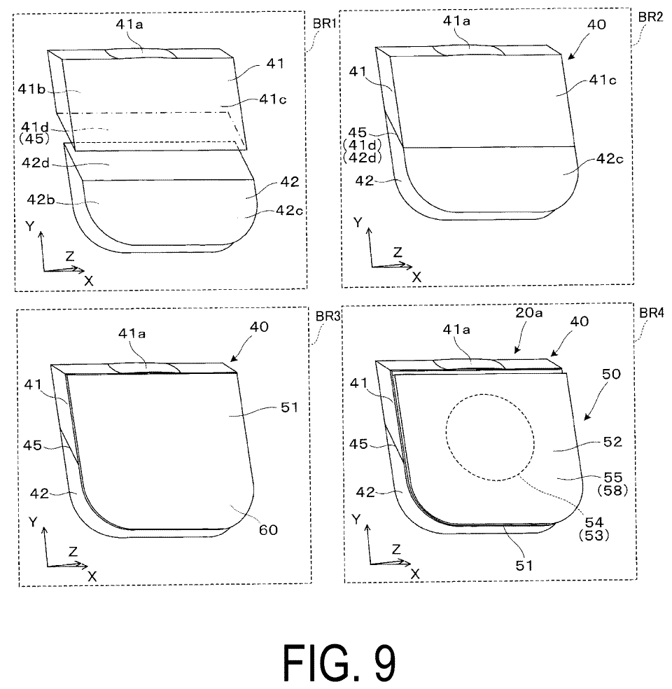

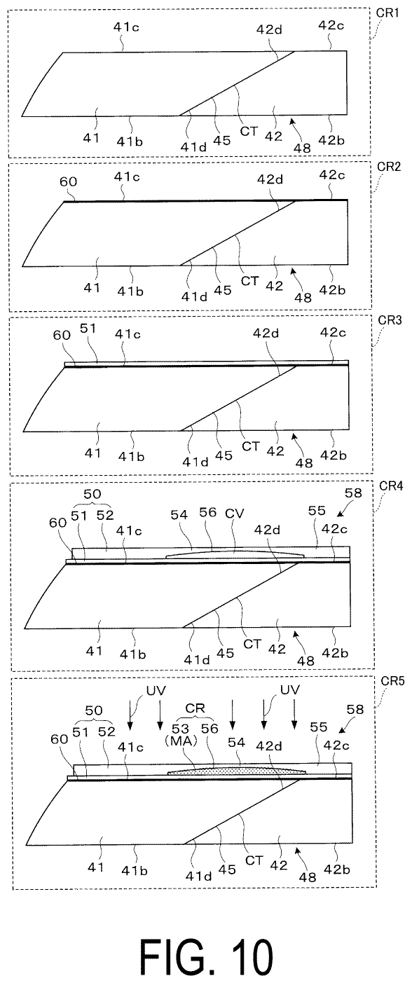

An example of the structure and assembly of the first display unit 20a constituting the first virtual image display device 100A will be described with reference to FIG. 9 and FIG. 10. In FIG. 9, regions BR1 to BR4 are perspective views for describing an assembly process of the first display unit 20a. In FIG. 10, regions CR1 to CR5 are cross-sectional views for describing the assembly process of the first display unit 20a. First, as illustrated in the region BR1 in FIG. 9, the first prism 41 and the second prism 42 are prepared. The first prism 41 and the second prism 42 are formed by injection molding of resin, for example. The first prism 41 is formed with the incident optical surface 41a, the inner surface 41b, the outer surface 41c, and the like. The second prism 42 is formed with the inner surface 42b, the outer surface 42c, and the like. Among these, the first prism 41 is formed with the polarized light separation film 45 on the inclined surface 41d by vacuum vapor deposition or other methods. As illustrated in the region BR2 of FIG. 9 and the region CR1 of FIG. 10, the first prism 41 and the second prism 42 are bonded on the inclined surfaces 41d and 42d to obtain the first flat plate member 40. Next, as illustrated in the region CR2 of FIG. 10, the angle selection film 60 is formed on the outer surfaces 41c and 42c of the first flat plate member 40 by vacuum vapor deposition or other methods. Next, as illustrated in the region BR3 of FIG. 9 and the region CR3 of FIG. 10, the quarter-wavelength plate 51 is bonded so as to face the outer surfaces 41c and 42c of the first flat plate member 40. As illustrated in the region BR4 of FIG. 9 and the region CR4 of FIG. 10, the compensation flat plate 55 and the quarter-wavelength plate 51 of the optical element 58 are brought into contact with each other. This forms a filling space CV between the compensation lens 54 and the quarter-wavelength plate 51 as a molding die of the second lens 53. The transmissive mirror 56 is formed on the concave surface of the compensation lens 54 facing the quarter-wavelength plate 51. Next, as illustrated in the region CR5 of FIG. 10, an adhesive MA, which is a material of the second lens 53, is injected from a flow path (not illustrated) formed by a groove provided in the optical element 58, and the adhesive MA is filled in the filling space CV corresponding to the second lens 53. Thereafter, the filled adhesive MA is cured by being irradiated with ultraviolet light UV or the like. Thus, the second lens 53 is formed in a bonded state between the quarter-wavelength plate 51 and the compensation lens 54. By doing this process, the assembly of the first display unit 20a is completed. Note that when the compensation flat plate 55 and the quarter-wavelength plate 51 are brought into contact with each other, the compensation plate 55 and the quarter-wavelength plate 51 may be bonded to each other with an adhesive.

The virtual image display device 100A, 100B or the optical unit 100 according to the first embodiment is, as described above, a direct virtual image type of virtual image display device including the display element 11 configured to emit the video light ML, the first lens 30 having a positive refractive power on which the video light ML from the display element 11 is incident, the first prism 41 on which the video light ML passed through the first lens 30 is incident, the second prism 42 bonded to the first prism 41, the second prism 42 forming the prism light-guiding member 48 having the parallel flat plate shape, the polarized light separation film 45 provided at a bonding site of the first prism 41 and the second prism 42, the polarized light separation film 45 having a flat surface shape, the polarized light separation film 45 being configured to selectively reflect the video light ML guided in the first prism 41 according to a polarization direction, the angle selection film 60 disposed on an outer surface in the prism light-guiding member 48, the outer surface on which the video light ML guided in the first prism 41 and then reflected at the polarized light separation film 45 is incident, the angle selection film 60 being configured to exhibit a different separation characteristic depending on an incident angle of the video light ML, the second lens 53 including the flat surface 53f provided facing the angle selection film 60, the second lens 53 having the plano-convex shape, the transmissive mirror 56 disposed on the convex surface 53g of the second lens 53, the transmissive mirror 56 being configured to partially reflect the video light ML reflected at the polarized light separation film 45 toward the polarized light separation film 45, the quarter-wavelength plate 51 disposed between the angle selection film 60 and the flat surface 53f of the second lens 53, and the compensation lens 54 including the concave surface 54f having a shape obtained by inverting the convex surface 53g of the second lens 53, the concave surface 54f being bonded to the convex surface 53g through the transmissive mirror 56, and the flat surface 55g parallel to the outer surface 41c of the first prism 41.

In the virtual image display device 100A, 100B or the optical unit 100, since a virtual image is directly formed without forming an intermediate image, a refractive power is ensured by using the first lens 30, the second lens 53, and the transmissive mirror 56, a magnification rate is ensured while an increase in optical path length is being suppressed, and thus, an increase in size of the optical system can be avoided.

### Second Embodiment

A virtual image display device and the like according to a second embodiment will be described below. Note that the virtual image display device according to the second embodiment is obtained by partially modifying the virtual image display device according to the first embodiment, and description of parts in common with those of the virtual image display device according to the first embodiment will be omitted.

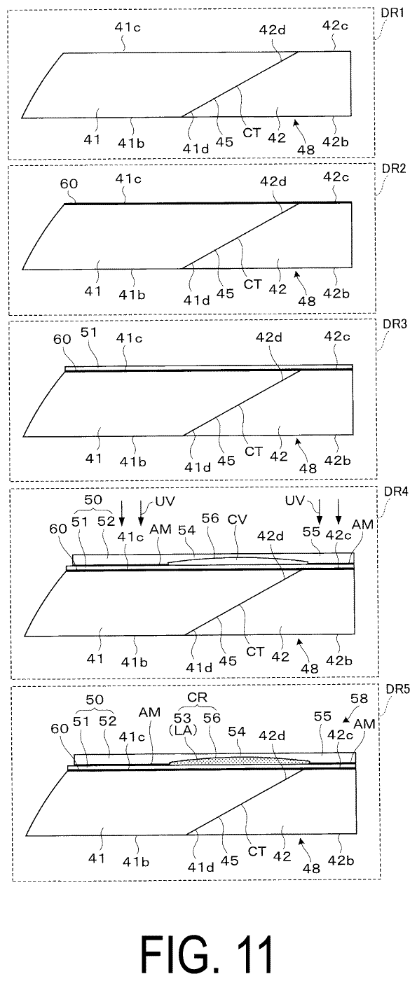

As illustrated in FIG. 11, the second lens 53 is formed of a liquid LA filled in the filling space CV between the compensation lens 54 and the quarter-wavelength plate 51. The liquid LA is a refractive index adjustment member having a refractive index equivalent to that of the compensation lens 54. Using the liquid LA having the refractive index equivalent to that of the compensation lens 54 for the material of the second lens 53 is effective in a case where the refractive index equivalent to that of the compensation lens 54 cannot be obtained by the adhesive. Examples of the refractive index adjustment member include Cargille standard refractive liquids (manufactured by MORITEX Corporation), specifically, Immersion oil type FF (with a refractive index of 1.4790), Optical gel 608 (with a refractive index of 1.46), Immersion liquid 5040 (with a refractive index from 1.4590 to 1.5700), and the like. Additionally, as the refractive index adjustment member, a refractive index matching film (manufactured by TOMOEGAWA CORPORATION), specifically, Fit Well (registered trademark, with a refractive index of 1.46) may be used.

In the cover member 52, a concave curved surface corresponding to the compensation lens 54 facing the second lens 53 is used as a molding die, and the quarter-wavelength plate 51 and the compensation flat plate 55 are bonded to each other with an adhesive. A flow path for injecting the material of the second lens 53 is formed in the compensation lens 54. After the quarter-wavelength plate 51 and the compensation flat plate 55 are bonded to each other, the refractive index adjustment member, which is the liquid LA, is filled in the filling space formed between the quarter-wavelength plate 51 and the compensation lens 54 through the flow path, and the periphery of the liquid LA is sealed with an adhesive. Thus, even when the second lens 53 is thin, the second lens 53 can be easily formed. The refractive index adjustment member has a refractive index equivalent to that of the compensation lens 54.

Hereinafter, an example of the structure and assembly of the first display unit 20a constituting the first virtual image display device 100A will be described. In FIG. 11, regions DR1 to DR5 are cross-sectional views for describing an assembly process of the first display unit 20a. As illustrated in the region DR1 of FIG. 11, the first prism 41 and the second prism 42 are bonded at the inclined surfaces 41d and 42d to obtain the first flat plate member 40. Next, as illustrated in the region DR2 of FIG. 11, the angle selection film 60 is formed on the outer surfaces 41c and 42c of the first flat plate member 40 by vacuum vapor deposition or other methods. Next, as illustrated in the region DR3 of FIG. 11, the quarter-wavelength plate 51 is bonded so as to face the outer surfaces 41c and 42c of the first flat plate member 40. As illustrated in the region DR4 of FIG. 11, the compensation flat plate 55 and the quarter-wavelength plate 51 of the optical element 58 are brought into contact with each other and bonded to each other by using an adhesive AM. Specifically, the adhesive AM is a photosetting resin such as an ultraviolet curable resin, and the compensation flat plate 55 and the quarter-wavelength plate 51 are bonded to each other by irradiating the adhesive AM with ultraviolet light UV or the like. Thus, the filling space CV is formed between the compensation lens 54 and the quarter-wavelength plate 51 as a shape retaining frame of the second lens 53. The transmissive mirror 56 is formed on the concave surface of the compensation lens 54 facing the quarter-wavelength plate 51. Next, as illustrated in the region DR5 of FIG. 11, the liquid LA, which is the material of the second lens 53, is injected from a flow path (not illustrated) formed by a groove provided in the optical element 58, and the filling space CV corresponding to the second lens 53 is filled with the liquid LA. Thereafter, the flow path is sealed with an adhesive. Thus, the second lens 53 is formed between the quarter-wavelength plate 51 and the compensation lens 54. By doing this process, the assembly of the first display unit 20a is completed.

### Third Embodiment

A virtual image display device and the like according to a third embodiment will be described below. Note that the virtual image display device according to the third embodiment is obtained by partially modifying the virtual image display device according to the first embodiment, and description of parts in common with those of the virtual image display device according to the first embodiment will be omitted.

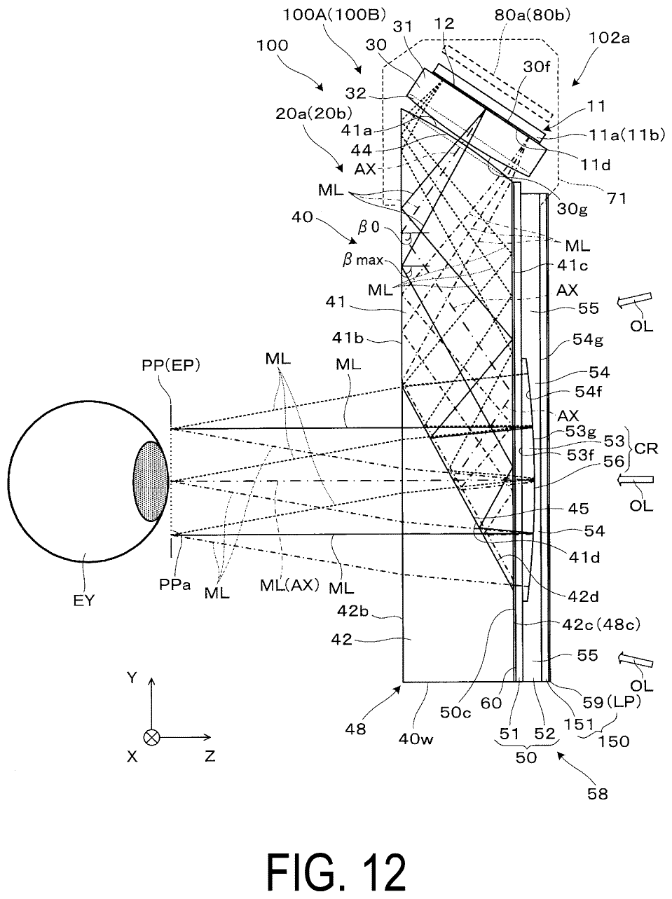

In the case of the first virtual image display device 100A illustrated in FIG. 12, in the first display unit 20a, for example, an s-polarized light transmissive polarizing plate 12 is disposed between the first lens 30 and the first image forming element 11a. However, the s-polarized light transmissive polarizing plate 12 is not essential for the function. In addition, in the first display unit 20a, a third flat plate member 150 is added to the second flat plate member 50 on an external environment side. The third flat plate member 150 is a video light blocking portion LP and includes a quarter-wavelength plate 151 positioned on the outer side and provided on the external environment side of the optical condensing/reflecting portion CR and a polarizing plate 59 that is provided on the external environment side of the quarter-wavelength plate 151 positioned on the outer side and that selectively absorbs the video light ML transmitted through the quarter-wavelength plate 151 according to the polarization direction. That is, in the first display unit 20a, the quarter-wavelength plate 51 positioned on the inner side and the quarter-wavelength plate 151 positioned on the outer side are disposed between the polarized light separation film 45 positioned on the inner side and the polarizing plate 59 positioned on the outer side.

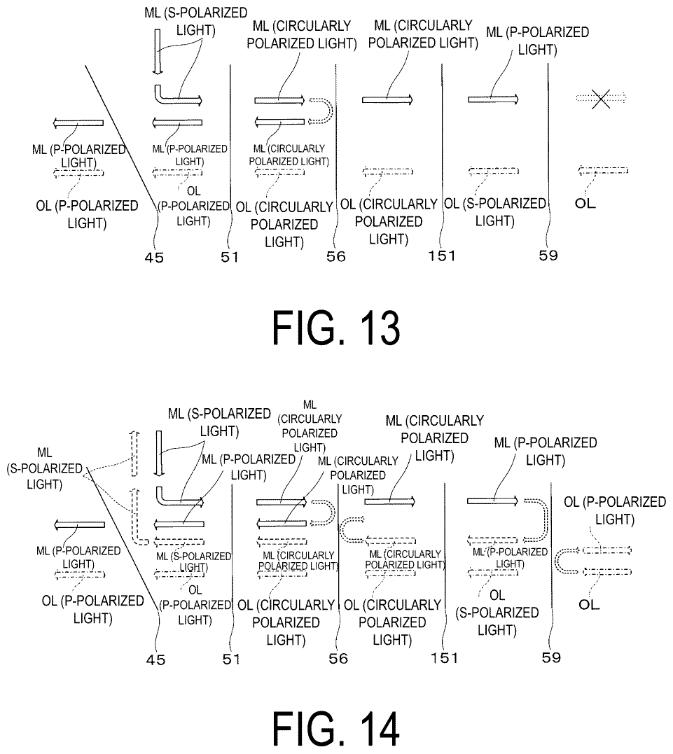

Referring to FIG. 13, the video light ML from the first image forming element 11a (see FIG. 12) includes only s-polarized light, and the video light ML of the s-polarized light incident on the polarized light separation film 45 is reflected at the polarized light separation film 45 without waste, passes through the quarter-wavelength plate 51 positioned on the inner side to become circularly polarized light, and is incident on the transmissive mirror 56. The video light ML of the circularly polarized light incident on the transmissive mirror 56 is partially reflected at the transmissive mirror 56 and passes through the quarter-wavelength plate 51 positioned on the inner side again in the reverse direction. The video light ML passed through the quarter-wavelength plate 51 positioned on the inner side in the reverse direction becomes p-polarized light, passes through the polarized light separation film 45, and is incident at the pupil position PP (see FIG. 12). On the other hand, the video light ML of the circularly polarized light transmitted through the transmissive mirror 56 becomes p-polarized light by passing through the quarter-wavelength plate 151 positioned on the outer side, is incident on the polarizing plate 59, and is mostly blocked by the polarizing plate 59. That is, the video light ML is blocked by the third flat plate member 150 and does not leak to the outside. That is, since the video light ML can be prevented from being observed from the outside, which can ensure privacy.

On the other hand, the external light OL incident on the polarizing plate 59 becomes only s-polarized light by passing through the polarizing plate 59, becomes circularly polarized light by passing through the quarter-wavelength plate 151 positioned on the outer side, and partially passes through the transmissive mirror 56. The external light OL of the circularly polarized light partially transmitted through the transmissive mirror 56 becomes p-polarized light by passing through the quarter-wavelength plate 51 positioned on the inner side, is transmitted through the polarized light separation film 45, and is incident on the pupil position PP (see FIG. 12).

FIG. 14 is a diagram for describing a modification of the first virtual image display device 100A illustrated in FIG. 12 and FIG. 13. In this case, it is assumed that the polarizing plate 59 constituting the third flat plate member 150 illustrated in FIG. 12 transmits s-polarized light and reflects p-polarized light.

FIG. 14 is different from FIG. 13 in that the video light ML of circularly polarized light partially transmitted through the transmissive mirror 56 becomes p-polarized light by passing through the quarter-wavelength plate 151 positioned on the outer side, and is mostly reflected at the polarizing plate 59 and does not leak to the outside of the polarizing plate 59. Note that the video light ML of the p-polarized light reflected by the polarizing plate 59 passes through the quarter-wavelength plate 151 positioned on the outer side again in the reverse direction. The video light ML of the p-polarized light passed through the quarter-wavelength plate 51 positioned on the outer side becomes circularly polarized light and is partially reflected by the transmissive mirror 56, but does not pass through the polarizing plate 59. The video light ML of the circularly polarized light partially transmitted through the transmissive mirror 56 passes through the quarter-wavelength plate 51 positioned on the inner side again in the reverse direction. The video light ML passed through the quarter-wavelength plate 51 positioned on the inner side becomes s-polarized light, is reflected at the polarized light separation film 45, and is returned in the direction of the first image forming element 11a.

On the other hand, the external light OL incident on the polarizing plate 59 becomes only s-polarized light by passing through the polarizing plate 59, becomes circularly polarized light by passing through the quarter-wavelength plate 151 positioned on the outer side, and partially passes through the transmissive mirror 56. The external light OL of the circularly polarized light partially transmitted through the transmissive mirror 56 becomes p-polarized light by passing through the quarter-wavelength plate 51 positioned on the inner side, is transmitted through the polarized light separation film 45, and is incident on the pupil position PP (see FIG. 12). Note that although the p-polarized light of the external light OL is reflected at the polarizing plate 59, there is no particular problem, and it is rather possible to prevent the surface of the first display unit 20a from becoming too dark.

### Modifications and Others

Although the present disclosure has been described with reference to the above-described embodiments, the present disclosure is not limited to the above-described embodiments and can be implemented in various modes without departing from the spirit of the disclosure. For example, the following modifications are possible.

Although the HMD 200 includes the first virtual image display device 100A and the second virtual image display device 100B in the above description, the HMD 200 may be configured such that a single virtual image display device of the first virtual image display device 100A or the second virtual image display device 100B is supported in front of the eyes by the support devices 100C.

In the method of assembling the first display unit 20a, the second lens 53 is formed in the assembling process, but the second lens 53 separately manufactured by injection molding or the like may be bonded.

In the cover member 52, the compensation flat plate 55 can be omitted. In this case, the quarter-wavelength plate 51 is disposed only in the range of the second lens 53, and the second lens 53 is covered with the compensation lens 54.

In the first prism 41 of the first flat plate member 40, the incident optical surface 41a may be omitted. In this case, the optical system does not include the lens portion 44.

The first lens 30 is not limited to a lens bonded to the first image forming element 11a, and may be a lens disposed separately from the first image forming element 11a.

The first prism 41 and the second prism 42 may be formed of glass instead of the resin material.

The first image forming element 11a may be a scanning-type display device including a laser light source or a scanner mirror.

According to a specific aspect of the present disclosure, there is provided a virtual image display device being a direct virtual image type, the virtual image display device including a display element configured to emit video light, a first lens having a positive refractive power, the first lens on which the video light is incident from the display element, a first prism on which the video light passed through the first lens is incident, a second prism bonded to the first prism, the second prism forming a prism light-guiding member having a parallel flat plate shape, a polarized light separation film provided at a bonding site of the first prism and the second prism, the polarized light separation film having a flat surface shape, the polarized light separation film being configured to selectively reflect the video light guided in the first prism in accordance with a polarization direction, an angle selection film disposed on an outer surface in the prism light-guiding member, on which the video light guided in the first prism and then reflected at the polarized light separation film is incident, the angle selection film being configured to exhibit a different separation characteristic depending on an incident angle of the video light, a second lens including a flat surface provided facing the angle selection film, the second lens having a plano-convex shape, a transmissive mirror disposed on a convex surface of the second lens, the transmissive mirror being configured to partially reflect the video light reflected at the polarized light separation film toward the polarized light separation film, a quarter-wavelength plate disposed between the angle selection film and the flat surface of the second lens, and a compensation lens including a concave surface having a shape obtained by inverting the convex surface of the second lens, the concave surface being bonded to the convex surface through the transmissive mirror, and a flat surface parallel to an outer surface of the first prism.

In the virtual image display device described above, since a virtual image is directly formed without forming an intermediate image, a refractive power is ensured by using the first lens, the second lens, and the transmissive mirror, which makes it possible to ensure a magnification rate while suppressing an increase in length of an optical path and to avoid an increase in size of the optical system.

In the virtual image display device according to the specific aspect of the present disclosure, the first lens, the prism light-guiding member, the polarized light separation film, the angle selection film, the second lens, the transmissive mirror, and the quarter-wavelength plate constitute an imaging optical system of a simple microscope type that forms an erect image, and the first prism internally reflects the video light twice while diverging the video light. In this case, a distance from the display element to the transmissive mirror can be easily shortened, the prism light-guiding member can be miniaturized, and the display element and the first lens can also be easily miniaturized.

In the virtual image display device according to the specific aspect of the present disclosure, the angle selection film is constituted by a dielectric multilayer film, transmits the video light when an incident angle on the angle selection film is equal to or less than 20°, and reflects the video light when the incident angle on the angle selection film is equal to or more than 40°.

In the virtual image display device according to the specific aspect of the present disclosure, a compensation flat plate provided around the compensation lens, the compensation flat plate extending parallel to the prism light-guiding member, is further provided. In this case, the external light incident on the periphery of the compensation lens can be observed in a manner similar to that of the external light incident into the compensation lens.

In the virtual image display device according to the specific aspect of the present disclosure, the angle selection film and the quarter-wavelength plate are bonded to each other.

In the virtual image display device according to the specific aspect, the first lens includes a light incident surface being a flat surface, the light incident surface being bonded to the display element, and a light emission surface being a convex surface. In this case, the first lens can function as a protective glass, and ensuring a thickness of the first lens to be equal to or larger than a predetermined thickness causes a foreign matter adhering to the surface of the first lens to be less noticeable.

In the virtual image display device according to the specific aspect, the first prism includes an incident optical surface having a positive refractive power, and the incident optical surface has an optical axis extending in a direction having an angle less than 90° with respect to a normal line of the inner surface. In this case, the display element is easily disposed on the further external environment side than the inner surface, and a situation in which the display element and the like are disposed close to a face and interference is likely to occur can be avoided, and the degree of freedom for the arrangement and size of a projection optical member is enhanced.

In the virtual image display device according to the specific aspect of the present disclosure, the polarized light separation film reflects the video light of s-polarized light, and transmits the video light of p-polarized light obtained by reflecting the video light at the transmissive mirror, and returning the video light through the quarter-wavelength plate.

In the virtual image display device according to the specific aspect of the present disclosure, the second lens is made of an adhesive configured to bond the compensation lens and the quarter-wavelength plate. In this case, even when the second lens is thin, the second lens can be easily formed.

In the virtual image display device according to the specific aspect of the present disclosure, the second lens is made of a liquid filled in a filling space between the compensation lens and the quarter-wavelength plate. In this case, even when the second lens is thin, the second lens can be easily formed. Using the liquid having a refractive index equivalent to that of the compensation lens as a material of the second lens is effective in a case where the adhesive having a refractive index equivalent to that of the compensation lens cannot be obtained. In addition, since the liquid is used for the second lens, it is not necessary to consider curing shrinkage or the like of the adhesive.

In the virtual image display device according to the specific aspect of the present disclosure, the liquid is a refractive index adjustment member in a liquid state, the refractive index adjustment member being filled between the compensation lens and the quarter-wavelength plate, the refractive index adjustment member being sealed with an adhesive around the refractive index adjustment member.

According to another aspect of the present disclosure, there is provided an optical unit being a direct virtual image type, the optical unit including a first lens having a positive refractive power, on which video light is incident from a display element configured to emit the video light, a first prism on which the video light passed through the first lens is incident, a second prism bonded to the first prism, the second prism forming a prism light-guiding member having a parallel flat plate shape, a polarized light separation film provided at a bonding site of the first prism and the second prism, the polarized light separation film having a flat surface shape, the polarized light separation film being configured to selectively reflect the video light guided in the first prism in accordance with a polarization direction, an angle selection film disposed on an outer surface in the prism light-guiding member, on which the video light guided in the first prism and then reflected at the polarized light separation film is incident, the angle selection film being configured to exhibit a different separation characteristic depending on an incident angle of the video light, a second lens including a flat surface provided facing the angle selection film, the second lens having a plano-convex shape, a transmissive mirror disposed on a convex surface of the second lens, the transmissive mirror being configured to partially reflect the video light reflected at the polarized light separation film toward the polarized light separation film, a quarter-wavelength plate disposed between the angle selection film and the flat surface of the second lens, and a compensation lens including a concave surface having a shape obtained by inverting the convex surface of the second lens, the concave surface being bonded to the convex surface through the transmissive mirror, and a flat surface parallel to an outer surface of the first prism.

What is claimed is:

1. A virtual image display device being a direct virtual image type, the virtual image display device comprising:
a display element configured to emit video light;
a first lens having a positive refractive power, on which the video light is incident from the display element;
a first prism on which the video light passed through the first lens is incident;
a second prism bonded to the first prism, the second prism forming a prism light-guiding member having a parallel flat plate shape;
a polarized light separation film provided at a bonding site of the first prism and the second prism, the polarized light separation film having a flat surface shape, the polarized light separation film being configured to selectively reflect the video light guided in the first prism in accordance with a polarization direction;
an angle selection film disposed on an outer surface in the prism light-guiding member, on which the video light guided in the first prism and then reflected at the polarized light separation film is incident, the angle selection film being configured to exhibit a different separation characteristic depending on an incident angle of the video light;
a second lens including a flat surface provided facing the angle selection film, the second lens having a plano-convex shape;
a transmissive mirror disposed on a convex surface of the second lens, the transmissive mirror being configured to partially reflect the video light reflected at the polarized light separation film toward the polarized light separation film;
a quarter-wavelength plate disposed between the angle selection film and the flat surface of the second lens; and
a compensation lens including a concave surface having a shape obtained by inverting the convex surface of the second lens, the concave surface being bonded to the convex surface through the transmissive mirror, and a flat surface parallel to an outer surface of the first prism.

2. The virtual image display device according to claim 1,
wherein the first lens, the prism light-guiding member, the polarized light separation film, the angle selection film, the second lens, the transmissive mirror, and the quarter-wavelength plate constitute an imaging optical system of a simple microscope type that forms an erect image, and
the first prism internally reflects the video light twice while diverging the video light.

3. The virtual image display device according to claim 1,
wherein the angle selection film is constituted by a dielectric multilayer film, transmits the video light when an incident angle on the angle selection film is equal to or less than 20°, and reflects the video light when the incident angle on the angle selection film is equal to or more than 40°.

4. The virtual image display device according to claim 1, further comprising:
a compensation flat plate provided around the compensation lens, the compensation flat plate extending parallel to the prism light-guiding member.

5. The virtual image display device according to claim 1,
wherein the angle selection film and the quarter-wavelength plate are bonded to each other.

6. The virtual image display device according to claim 1,
wherein the first lens includes a light incident surface being a flat surface, the light incident surface being bonded to the display element, and a light emission surface being a convex surface.

7. The virtual image display device according to claim 1, wherein
the first prism includes an incident optical surface having a positive refractive power, and
the incident optical surface has an optical axis extending in a direction having an angle less than 90° with respect to a normal line of the inner surface.

8. The virtual image display device according to claim 1, wherein
the polarized light separation film reflects the video light of s-polarized light, and transmits the video light of p-polarized light obtained by reflecting the video light at the transmissive mirror, and returning the video light through the quarter-wavelength plate.

9. The virtual image display device according to claim 1, wherein
the second lens is made of an adhesive configured to bond the compensation lens and the quarter-wavelength plate.

10. The virtual image display device according to claim 1, wherein
the second lens is made of a liquid filled in a filling space between the compensation lens and the quarter-wavelength plate.

11. The virtual image display device according to claim 10, wherein
the liquid is a refractive index adjustment member in a liquid state filled between the compensation lens and the quarter-wavelength plate, the refractive index adjustment member being sealed with an adhesive around the refractive index adjustment member.

12. An optical unit being a direct virtual image type, the optical unit comprising:
a first lens having a positive refractive power, on which video light is incident from a display element configured to emit the video light;
a first prism on which the video light passed through the first lens is incident;
a second prism bonded to the first prism, the second prism forming a prism light-guiding member having a parallel flat plate shape;
a polarized light separation film provided at a bonding site of the first prism and the second prism, the polarized light separation film having a flat surface shape, the polarized light separation film being configured to selectively reflect the video light guided in the first prism in accordance with a polarization direction;
an angle selection film disposed on an outer surface in the prism light-guiding member, on which the video light guided in the first prism and then reflected at the polarized light separation film is incident, the angle selection film being configured to exhibit a different separation characteristic depending on an incident angle of the video light;
a second lens including a flat surface provided facing the angle selection film, the second lens having a plano-convex shape;
a transmissive mirror disposed on a convex surface of the second lens, the transmissive mirror being configured to partially reflect the video light reflected at the polarized light separation film toward the polarized light separation film;
a quarter-wavelength plate disposed between the angle selection film and the flat surface of the second lens; and
a compensation lens including a concave surface having a shape obtained by inverting the convex surface of the second lens, the concave surface being bonded to the convex surface through the transmissive mirror, and a flat surface parallel to an outer surface of the first prism.
